(19) United States
(12) Patent Application Publication
(10) Pub. No.: US 2003/0100205 A1
(43) Pub. Date: May 29, 2003

(54) Device for the electrically conductive contacting of an electrically conductive part of an elongated body, in particular a tube or cable

(76) Inventor: Britta Daume, Burgwedel (DE)

Correspondence Address: SHLESINGER, ARKWRIGHT & GARVEY LLP, 3000 South Eads Street, Arlington, VA, 22202, US

(21) Appl. No.: 10/285,570

(22) Filed: Nov. 1, 2002

(30) Foreign Application Priority Data
Nov. 1, 2001 (DE) 201 17 689.0

(51) Int. Cl. H01R 4/66

(52) U.S. Cl. 439/100

(57) ABSTRACT

A device for the electrically conductive contacting of an electrically conductive part of an elongated body, in particular a cable or tube, has a base for lying on the body to be contacted and at least one contact element located, in the installed position, between the base and the body to be contacted for establishing an electrically conductive connection with the electrically conductive part of the body to be contacted. The at least one contact element includes a sheet metal structure of an alloy which consists at least of 94.5% copper (Cu) and has 2-4% nickel (Ni), 0.5-1% silicon (Si), and 0.05-0.25% magnesium (Mg).

### CROSS REFERENCE TO RELATED APPLICATIONS

This application claims priority of German application No. 201 17 689.0, filed Nov. 1, 2001, which is incorporated herein by reference.

### FIELD OF THE INVENTION

The invention relates to a contacting device of the type for electrically conductively contacting an electrically conductive part of an elongated body, the contacting device including a base and a contact element for establishing the electrically conductive connection between the base and the electrically conductive part of the body to be contacted.

### BACKGROUND OF THE INVENTION

Contacting devices of this type find numerous applications, for example, as so-called grounding sleeves for the grounding of cables or tubes. They have as a rule a base which is preferably formed at least partially of an elastic material and which lies on the body to be contacted. At least one preferably metallic contact element which, in the installed position, lies on the electrically conductive part of the body to be contacted, is the electrically conductive connection to the body to be contacted. The contact element is located, in the installed position of the device, between the body to be contacted and the base and is held on the base's side facing the body to be contacted.

EP 0 744 788 A1 discloses a generic contacting device for the electrically conductive contacting of a stripped outer conductor of a coaxial cable. The base of the device has a band-like, metallic carrier element which is sheathed on its outer surface and at its axial edges by an elastic material. On the side facing, in the installed position, the body to be contacted, on the contrary, no covering by elastic material is provided. The base is laid, in the manner of a clamp, around the outer conductor of the coaxial cable to be contacted, which is annularly stripped of its electrically insulating sheath. The base's sides consisting of electrically insulating material are supported in this case on the remaining edges of the sheath while the uncoated part of the carrier element comes to lie at a radial distance from the bare or exposed area of the tube. This radial distance is bridged by a contact element which is implemented as a band of a copper braid. This band lies on the bare tube as well as on the bare part of the carrier element of the base body and thus produces the electrically conductive contacting.

EP 0 982 524 A1 discloses a similar device in which, however, a separate contact element is omitted. Rather, the metallic carrier element is equipped with contact projections which lie elastically deformably on the electrically conductive part of the body to be contacted and thus act as contact elements. As contact projections, in particular, profilings such as, for example, tongue-like punch-outs have been proposed. As a material for the contact projections or the carrier element from which the contact projections are formed, slightly alloyed copper, i.a., has been proposed.

The known contacting devices have the disadvantage that, in the installed position in which the clamp-like base is stretched around the body to be contacted, they exert on the body to be contacted a relatively strong force which is difficult to control. This criterion, which in the case of the contacting of tubes is basically of little interest, gains a significant importance in the contacting of cables, in particular of wave-guiding coaxial cables. In the grounding of such cables the outer conductor is customarily stripped and contacted electrically conductively with the aid of a contacting device, e.g., a so-called grounding sleeve. After removal of the insulation layer, which often also assumes a not insignificant supporting function, the outer conductor is relatively sensitive to deformations. Such deformations, in particular pinching, can result from too great pressure. Even slight pinchings have, as a consequence, an increase of the wave resistance in the cable , which leads under unfavorable conditions to reflections and faulty adaptation to subsequent structural components. As a result, the efficiency of the wave guide is reduced.

An object of the invention is to improve upon known devices so that the pressure exerted on a body to be contacted can be reduced.

This object is realized by the teachings of an inventive device for electrically conductively contacting electrically conductive part of an elongated body, the device including a base for lying on the body to be contacted, at least one contact element for establishing an electrically conductive connection between the base and the part of the body to be contacted, and the at least one contact element may include a sheet metal structure of an alloy including at least about 94.5% copper, 2-4% nickel, 0.5-1% silicon, and 0.05-0.25% magnesium.

Through the particular choice of material which aims at an alloy which consists at least of 94.5% copper (Cu) and has 2-4% nickel (Ni), 0.5-1% silicon (Si), and 0.05-0.25% magnesium (Mg), it becomes possible to produce contact elements as sheet metal structures which can be made thinner in their sheet thickness than corresponding profiled metal sheets of other materials without, in so doing, losing the properties necessary for their function, for example elastic and/or supporting properties. With thinner profiled metal sheets as contact elements, lower forces of compression on the body to be contacted can be realized without the intended, electrically conductive connection suffering as a result.

A further advantage follows from the clear saving in material due to the thinner structure of the profiled metal sheets. Thereby production costs can be spared at a level which more than compensates for the added costs which follow from the, at present, still higher cost of the material used according to the invention.

The advantages of the invention are useful in the case of contacting devices which have a separate contact element between the body to be contacted and the base, as well as in the case of those in which the carrier element is already equipped with contact projections acting as contact elements. In particular, the advantage of weight savings is expressed above all in the latter type of contacting device since in it a particularly high percentage of mass of the entire device can be replaced by the alloy according to the invention.

It has shown itself to be particularly advantageous to choose the alloy so that it consists at least of 90.8% copper (Cu) and contains 2.7-3.3% nickel (Ni), 0.6-0.7% silicon (Si), and 0.1-0.2% magnesium (Mg) . Preferably usable therein in this case is the alloy defined in the American unified numbering system UNS as “C 70250” with essentially 96.2% copper, 3% nickel, 0.65% silicon, and 0.15% magnesium. This type of material has properties which make it particularly suitable for use as a contact element of a generic or known contacting device, namely an electrical conductivity of more than 20 MS/m, a thermal conductivity of 180 to 200 W/(mK), a thermal expansion coefficient of 17 to 18 10⁻⁶/K, a density of 8.7 to 9.0 g/cm³, and a modulus of elasticity of 120 to 140 kN/mm². Moreover, the material can be easily processed and retains its mechanically favorable, elastic properties even on forming as a thin sheet, for example of less than 0.5, or even under 0.4, mm. Contact elements according to the invention are thus structured in one embodiment with a sheet thickness of about 0.4 mm. The special form of the contact elements can be implemented within wide limits and in adaptation to the special conditions.

In another embodiment the base of the contacting device according to the invention consists of an essentially band-like, metallic carrier element which can be stretched in the form of a clamp around the body to be contacted. It is partially encircled by an elastic material so that the carrier element's side facing, in the installed position of the device, the body to be contacted remains at least partially free of elastic material. In this way the at least one contact element in the installed position can produce an electrically conductive contact between the electrically conductive part of the body to be contacted and the carrier element. When so doing, the at least one contact element can, for example, be configured as at least one projection of the contact element, where the contact projection(s) is/are preferably of one piece and particularly advantageously of the same material as the carrier element. The contact projection(s) can in that case be structured as round, triangular, rectangular, trapezoidal, or similar profilings of the carrier element or as, for example, tongue-like punch-outs. In so doing the tongues can be aligned in the circumferential direction as well as in the axial direction of the body to be contacted. In particular, the latter variant can be advantageously realized by the formation of a single meandering punched-out or cut line in the circumferential direction of the carrier element. In so doing two rows of tongues lying opposite one another and toothed in one another arise which, in the installed position, lie, axially on the body to be contacted, in alignment opposite to one another. In this way a plurality of reliable contact points can be created in a particularly simple processing step.

In the case of the aforementioned embodiments the uniformity of material of the contact projections and the carrier elements is particularly advantageous. It is essentially more work-intensive, but entirely possible within the scope of the invention, to connect the contact projection(s) to the carrier element by means of a material. Thereby different materials can be chosen for the carrier element and contact projection.

In a fundamentally different embodiment, the contact element implemented according to the invention as a profiled metal sheet of a particular alloy is structured as a separate component which lies, in the installed position, between the electrically conductive part of the body to be contacted and the band-like carrier element of the base. . In order to produce a reliable, electrically conductive connection, the contact element in this case is preferably profiled to be wave-like, meandering, or zigzag. In each case it is worth it to strive to structure the contact elements so that they lie, in the installed position, as an elastic spring on the body to be contacted.

Additional advantages of the invention follow from the detailed description of the embodiments and the accompanying schematic drawings.

### BRIEF DESCRIPTION OF THE DRAWINGS

FIG. 1 is a perspective view of a contacting device,

FIG. 2 is a perspective view of a contacting device in the installed position,

FIG. 3 is a schematic radial section through a contacting device in the installed position,

FIG. 4 is in sectional lateral view, various embodiments of separate contact elements,

FIG. 5 is a schematic plan view of the inner side of a contacting device in a first embodiment,

FIG. 6 is a schematic plan view of a carrier element of a contacting device of a second embodiment , and

FIG. 7 is a schematic axial section through a contacting device in a second embodiment in the installed position.

Relative terms such as up, down, left, and right are for convenience only and are not intended to be limiting.

### DETAILED DESCRIPTION OF THE INVENTION

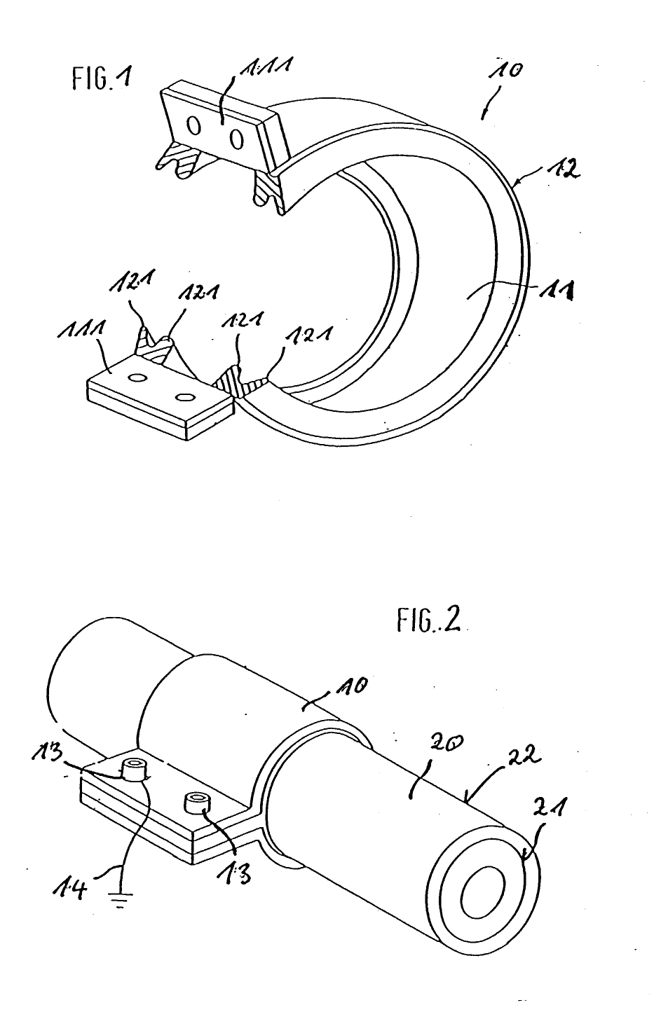

FIG. 1 represents a schematic view of an embodiment of a contacting device 10 for cables or tubes. A metallic carrier element 11 configured in the form of a band is in the form of a clamp, as FIG. 2 shows, which can be stretched around a body 20 to be contacted. For this, it has, on its narrow sides, angled tabs 111 which, for example, can be connected to one another by means of screws 13. The carrier element 11 is encircled, at least on its outer, in the installed position, side, by an elastic sheath 12. This sheath has in addition sealing lips 121 which extend in the circumferential direction of the body to be contacted and are axially offset from one another. A face 112 of carrier element 11, i.e., the face which faces, in the installed position, the body 20 to be contacted, is not covered by the sheath 12.

In FIG. 2 the position of such a contacting device 10 installed around body 20 to be contacted, namely coaxial cable 20, is shown schematically. In the area of the contacting device 10, as can be seen in FIG. 7, an outer sheath 22 of the coaxial cable 20 has been removed so that an electrically conductive surface 21 of the outer conductor of the coaxial cable lies opposite, at a distance, a blank face 112 of the carrier element 11.

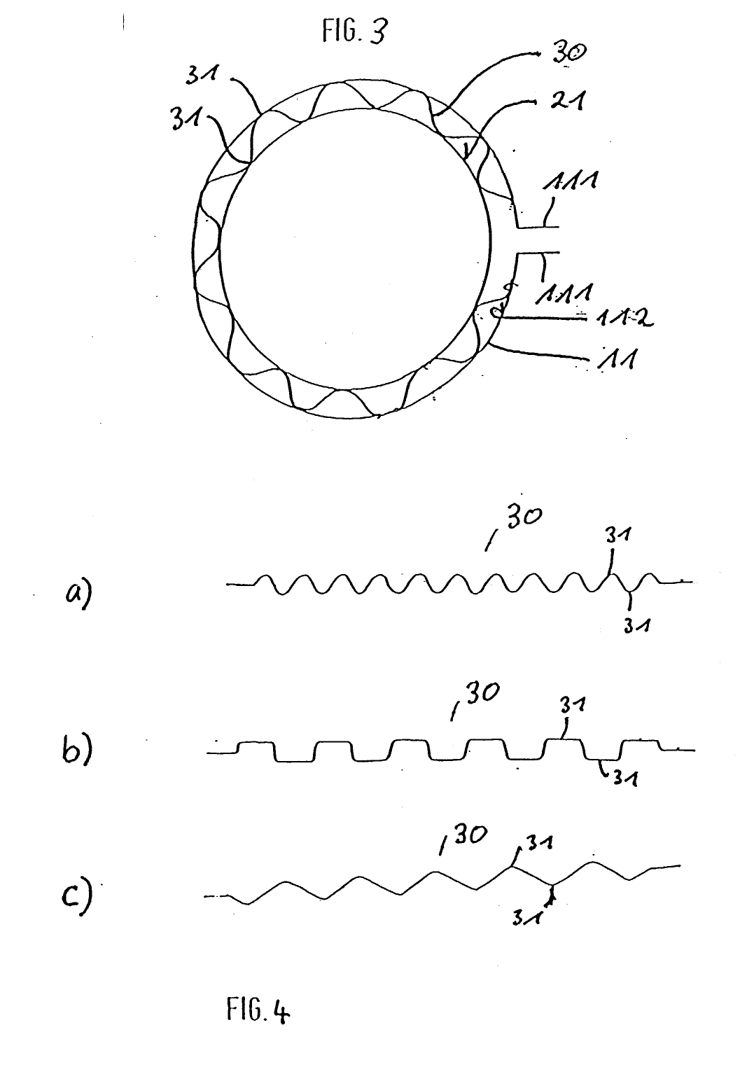

This distance can, as shown in FIG. 3, be bridged by a contact element 30. FIG. 3 represents a radial section though a contact element in the installed position. The embodiment in FIG. 3 is a separate contact element 30 which lies in the area of the contacting device 10 between the electrically conductive surface 21 of the coaxial cable 20, i.e., the surface to be contacted, and the blank face 112 of the carrier element 11. In the schematic representation of FIG. 3 the sheath 12, of elastic material of the base body, is not represented.

According to the invention the contact element 30 consists of a metal sheet of an alloy which consists at least of 94.5% copper (Cu) and has 2-4% nickel (Ni), 0.5-1% silicon (Si), and 0.05-0.25% magnesium (Mg) . In the embodiment the alloy components are present substantially in the following percentages: 96.2% Cu, 3% Ni, 0.65% Si, and 0.15% Mg. The exact percentages may likewise be used.

The contact element 30 can be configured in the most various ways. Three embodiments are represented in FIG. 4.

In FIG. 4 the contact element 30 is a sheet of metal, made of the above-specified alloy according to the invention, and profiled to be either wave-like (a), meandering (b), or zig-zag (c). The profiling is in this case structured or configured so that the arrangement of the contact element 30 between the carrier element 11 and the outer conductor 21 may have the character of an elastic spring. In this way irregularities in the stripped sheath 22 of the coaxial cable 20 can be compensated for without difficulties. As can clearly be seen in FIG. 3, the electrically conductive contact is produced via several contact points formed by the projections 31. It is obvious that thereby a radial compression force acts on the outer conductor 21. This force must be dimensioned so that in fact a reliable, electrically conductive contacting occurs, and so that, despite the lack of stability due to the stripped sheath 22, no pinching of the outer conductor 21 arises which would lead to disturbances of the wave guide.

FIG. 5 shows the plan view of the inner side of a contacting device with a separate contact element 30 according to FIGS. 3 and 4 in a further embodiment. The contact element 30 here is held, with a holding element, on the base's side facing, in the installed position, the body 20 to be contacted. The holding element may include pockets 121 which are formed on the inner side of the carrier element 11 from the elastic sheath 12. The ends of the separate contact element 30 can be inserted into pockets 122, which, in particular, significantly simplifies the installation of the contacting device. The area of the inner side 112 of the carrier element 11 between the pockets 121 is not covered by the sheath so that the electrically conductive connection between the carrier element and the outer conductor 21 of the coaxial cable 20, i.e., the outer conductor to be contacted, can be made.

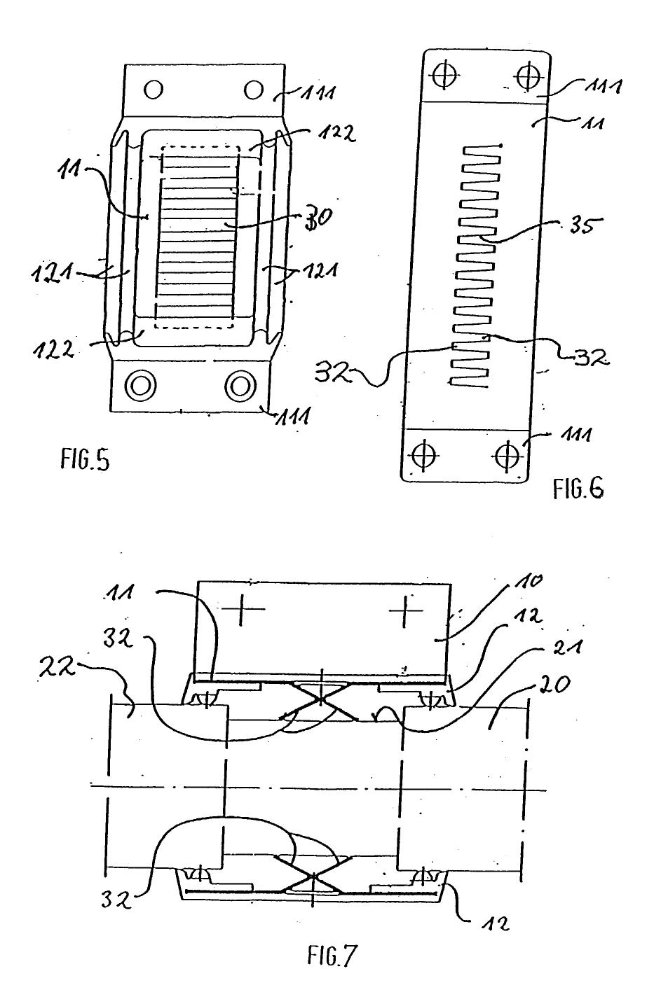

FIG. 6 shows a fundamentally different embodiment of the contacting device 10 according to the invention.

In FIG. 6 a separate contact element is omitted and, instead of this, the carrier element 11 itself is provided with contact projections 32. In the particularly advantageous embodiment shown in FIG. 6, the contact projections 32 consist of tongues 32 lying opposite one another and extending in the axial direction of the body 20 to be contacted. Their mode of action is illustrated in FIG. 7. The tongues 32 can be produced particularly simply by a penetrating, meandering punched-out or cut line 35 being punched out in the carrier element 11, as represented in FIG. 6. The resulting tongues 32, engaging as teeth in one another, can by a slight bending, be brought into elastically spring-like, electrically conductive contact.

Additional embodiments, such as contact projections formed as round, triangular, rectangular, or similar profilings of the carrier element 11, are not represented in detail in the drawings. While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

What is claimed is:

1. Device for the electrically conductive contacting of an electrically conductive part of an elongated body to be contacted, comprising:
a) a base for lying on the body to be contacted;
b) at least one contact element located, in the installed position, between the base and the body to be contacted for establishing an electrically conductive connection with the electrically conductive part of the body to be contacted; and
c) the at least one contact element includes a sheet metal structure of an alloy consisting essentially of 94.5% copper (Cu), 2-4% (Ni), 0.5-1% silicon (Si), and 0.05-0.25% magnesium (Mg).

2. Device according to claim 1, wherein:
a) the alloy consists essentially of:
Ni 2.7 to 3.3%,
Si 0.6 to 0.7%,
Mg 0.1 to 0.2%, and
Cu≧95.8%.

3. Device according to claim 1, wherein:
a) the alloy consists essentially of
Ni 3%,
Si 0.65%,
Mg 0.15%, and
Cu≧96.2%.

4. Device according to claim 1, wherein:
a) the alloy of the at least one contact element is an alloy defined in the American unified numbering system UNS as “C 70250”.

5. Device according to claim 1, wherein:
a) the electrical conductivity of the at least one contact element at room temperature is at least substantially equal to 20 MS/m.

6. Device according to claim 1, wherein:
a) the thermal conductivity of the at least one contact element at room temperature is about 180 to 200 W/(m K).

7. Device according to claim 1, wherein:
a) the thermal expansion coefficient of the at least one contact element at room temperature is about 17 to 18 10⁻⁶/K.

8. Device according to claim 1, wherein:
a) the density of the alloy from which the at least one contact element is made is 8.7 to 9.0 g/cm³.

9. Device according to claim 1, wherein:
a) the modulus of elasticity of the alloy from which the at least one contact element is made is about 120 to 140 kN/mm².

10. Device according to claim 1, wherein:
a) a metal sheet thickness of the at least one contact element is not greater than 0.5 mm.

11. Device according to claim 10, wherein:
a) the metal sheet thickness of the at least one contact element is not greater than 0.4 mm.

12. Device according to claim 1, wherein:
a) the base includes a substantially band-like, metallic carrier element clampable around the body to be contacted;
b) said carrier element is partially encircled by an elastic material so that a side of the carrier element facing, in the installed position of the device, the body to be contacted, remains at least partially free of elastic material so that the at least one contact element, in the installed position, establishes an electrically conductive contact between the electrically conductive part of the body to be contacted and the carrier element.

13. Device according to claim 12, wherein:
a) the at least one contact element is configured as at least one contact projection of the carrier element.

14. Device according to claim 13, wherein:
a) the at least one contact projection is integral with the carrier element.

15. Device according to claim 14, wherein:
a) the at least one contact projection is made of the same alloy as the carrier element.

16. Device according to claim 14, wherein:
a) the at least one contact projection is configured as one of a round, triangular, rectangular, and trapezoidal profiling of the carrier element.

17. Device according to claim 14, wherein:
a) the at least one contact projection is configured as a tongue-like punch-out of the carrier element.

18. Device according to claim 12, wherein:
a) the at least one contact projection is configured as a separate contact element.

19. Device according to claim 18, wherein:
a) the at least one separate contact element is configured as a band profiled to be one of wave-like, meandering, and zig-zag in cross-section.

20. Device according to claim 18, wherein:
a) the at least one separate contact element is held, by a holding element, on the base's side facing, in the installed position, the body to be contacted.

21. Device according to claim 12, wherein:
a) the at least one contact element in the installed position, resiliently contacts the electrically conductive part of the body.
